(19) United States
(12) Patent Application Publication
(10) Pub. No.: US 2008/0223353 A1
(43) Pub. Date: Sep. 18, 2008

(54) Oven for Cooking Foods

(75) Inventor: Corrado Cristiani, Gaggio in Piano (Modena) (IT)

Correspondence Address: PEARNE & GORDON LLP, 1801 EAST 9TH STREET, SUITE 1200, CLEVELAND, OH, 44114-3108, US

(73) Assignee: ANGELO PO GRANDI CUCINE S.P.A., I-41042 Carpi (Modena) (IT)

(21) Appl. No.: 11/867,949

(22) Filed: Oct. 5, 2007

(30) Foreign Application Priority Data
Mar. 15, 2007 (IT) MO2007A000094

(51) Int. Cl. A21B 1/08; A21B 3/00

(52) U.S. Cl. 126/20; 126/21 A

(57) ABSTRACT

An oven for cooking foods, comprising: a cooking compartment, internally of which a controlled heating cycle can be actuated; one or a plurality of heating elements, predisposed to generate and transmit a determined heat power internally of the cooking compartment; one or a plurality of atomizers, predisposed to controlledly send atomized water onto or in proximity of at least one of the one or the plurality of heating elements; means for control, predisposed to actuate the determined heat cycle internally of the cooking compartment by controlling the one or the plurality of heating elements in a partialisation cycle of the heat power generated and/or transmitted to the cooking compartment by the one or the plurality of heating elements, in which partialisation cycle a temperature of at least one of the heating elements is maintained at a level which is sufficient to cause evaporation of the atomized water.

### BACKGROUND OF THE INVENTION

In ovens for cooking food products, the gastronomic results obtained depends on many factors, such as the temperature, cooking time, ventilation conditions, the shape of the cooking compartments and the level of moisture in the cooking environment.

The greater or lesser quantity of moisture in the cooking compartment, correctly combined with predetermined temperature values, increases or decreases heat transfer and also leads to special gastronomic results such as boiling, browning, obtaining a crust, drying, and other and various effects which can be obtained on the surface and inside the food subjected to the cooking process.

An efficient steaming system means that some cooking times can be reduced to even a quarter of that usually needed for some forms of cooking, and also enables the cooking temperature to be lowered, thus limiting the degradation of the nutritional elements in the food and maintaining the aesthetic and flavor qualities of the ingredients which contribute to the success of the cooking process, not only from a hygienic and nutritional point of view, but also in terms of the taste and appeal of the cooked food.

Some cooking recipes require abundant presence of steam, so much so that the process is known as “steaming” and the ovens for performing this process are known as “steamers” or “mixed” or “combined”, if they are able to combine steaming with other cooking methods.

The generation of steam needed for correctly steaming food can be obtained with various technological solutions, generally grouped under two ways or systems for steam production.

The first of these comprises steam generators that are external of the cooking compartment, and goes under the general heading of boilers; the second employs steam-producing systems located internally of the cooking compartment; these exploit the presence of heat inside the cooking compartment in order to obtain the required steam production.

Both the systems exhibit some advantages and disadvantages, such as to render neither decidedly preferable to the other.

Ovens having external steam generators, or boilers, are able to produce large quantities of steam, but require expensive components and a considerable heating power which is exclusively dedicated to the production of steam. Boiler-equipped ovens are high performance as regards steam generation and obtain excellent cooking results at the cost of large investments and high energy consumption.

The cost of realizing boiler-equipped ovens is generally higher due to the safety and protection devices that have to be included because of the presence of an external recipient predisposed for the production and containing of steam, which can be subject to a higher pressure to atmospheric. Further, pipes and connections have to be provided for the transport and containing of the pressurized steam and for its injection into the cooking compartment.

A further drawback of ovens provided with external boilers is that there is a delay between starting up the boiler heating system and the time at which the steam produced is actually available for injection into the cooking compartment. This leads to a consequent delay in the start of the cooking process, or when the cooking process is to be switched, in particular when passing from a dry-cooking cycle to a steam-cooking cycle.

The overall cost of boiler-equipped ovens is penalized by the inevitable loss of heat the boiler is subject to. This loss of heat can be limited only by high spending on heat insulation for the boiler and the steam-carrying conduits. In any case the overall heat performance of the oven is never particularly high. Costs are added-to even more by the formation and depositing of lime scale. These accumulations of scale require expensive maintenance and cleaning operations both of the boiler and to the piping.

Ovens which directly produce steam internally of the cooking compartment are less subject to the problems and dangers connected with the formation and deposit of lime scale. However, they do have certain drawbacks.

An oven for food product cooking is always provided with a cooking compartment in which the foods to be cooked are generally housed on grids, grills, supports or in containers.

Internally of the cooking chamber there are usually heating elements which provide the heat for cooking. These heating elements can be constituted by one or more electrical resistances, or by one or more heat exchangers which transmit the heat coming from one or more gas burners to the air in the cooking compartment. In some cases the heat exchangers can be heated by other heat sources, exploiting the electromagnetic properties of the materials, such as for example dielectric energy loss or parasite currents. To improve air circulation and heat exchange from the heat source towards the food product to be cooked, a ventilator element can be used, such as a blade or propeller fan rotated by a motor.

These heating elements are generally arranged in a zone of the cooking compartment which is partly separated from the zone in which the foods to be cooked are placed. The two zones are partially separated by surfaces of various shapes which have the function of conveying and guiding the ventilated air flows and contribute to improving the heat exchange required in order to transfer heat energy from the primary heat source to the foods.

An example of this type of oven, where there is a direct generation of the steam internally of the cooking chamber of an oven, is described in patent EP0640310. In the oven described in this patent, the steam is produced particularly efficiently by injecting water, via an atomizer device, directly onto the heating elements which produce the heat required by the cooking process. The finely-atomized water is turned into steam on contact, or in the immediate vicinity of the heating elements, and contributes to the transfer of heat towards the food products which are to be cooked.

Ovens in which there is a direct steam generation internally of the cooking compartment, or in an environment placed in communication with the cooking compartment, exhibit numerous advantages with respect to ovens having external boilers. In particular, direct-generation steam ovens offer lower heat loss externally of the cooking compartment, as all the energy needed for cooking and steam generation is created in the cooking compartments. Further, these ovens offer a faster response to production demands for steam during a cooking operation.

A further advantage is that as there is no external boiler, direct-steam-generating ovens are overall less subject to problems related to accumulation of lime scale, and therefore are safer and more reliable, as well as less expensive to build, to run and to maintain.

Though they offer many advantages with respect to ovens with boilers, ovens with internal steam production present some drawbacks.

The heating elements, which are provided with gas burners or internal electrical elements or other heat sources, can be usefully applied in the production of steam only during those intervals of time when they are turned on and operating. To enable good heat regulation in the cooking chamber, necessary for correct cooking of food, the heating elements are not turned on for the whole cooking process.

In the most frequent case, a temperature value is selected that corresponds to the temperature the operator wishes to maintain in the cooking chamber during a certain stage of the cooking process. Close to, or on reaching this temperature, the heating elements are turned off to prevent over-shooting the required predetermined temperature. During the periods in which the heating elements are off, production of steam is lowered or even stopped.

### SUMMARY OF THE INVENTION

The aim of the present invention is to provide an oven for food cooking which enables a steam production to be obtained, which steam production is free of the time limitations linked with the operating cycle of the heating elements and which can also be continuous and constant in flow. This aim and more besides are all attained by the oven described in claim 1 of the appended claims.

### BRIEF DESCRIPTION OF THE DRAWINGS

Further characteristics and advantages of the invention will better emerge from the detailed description that follows, made with reference to the accompanying figures of the drawings, which are provided by means of non-limiting example, and in which:

FIG. 1 is a schematic view of the oven of the present invention;

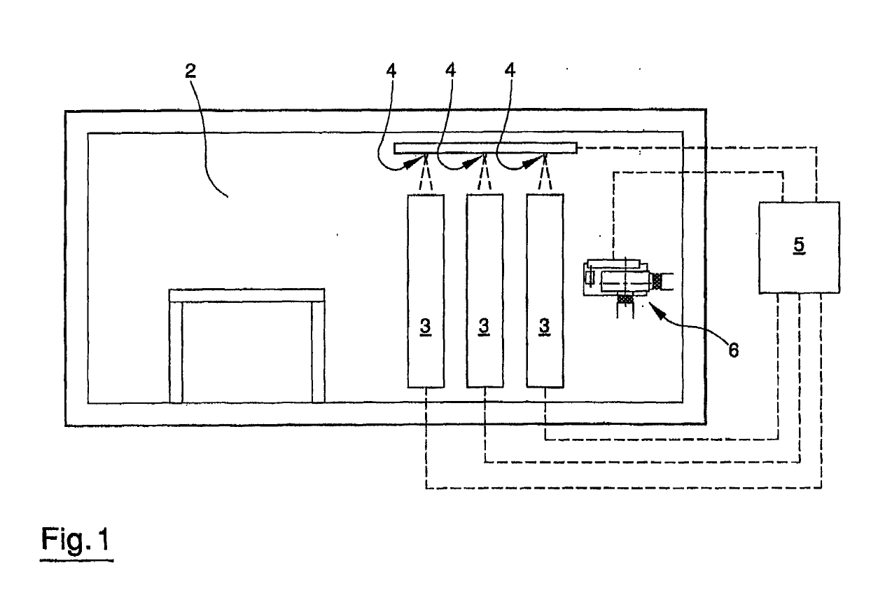

FIG. 2 is a series of temperature graphs according to the times of the steam, the cooking chamber and the product to be cooked;

FIGS. 3 and 4 show examples of graphs illustrating the progress of the power and energy in two cooking processes using approximately the same total energy, with one of them using a circuit solution so that the heating power is almost never zeroed during heat regulation, but is regulated and reduced by a value which is sufficient to maintain the generation of steam in at least a zone in direct communication with the cooking compartment.

### DESCRIPTION OF THE PREFERRED EMBODIMENTS

With reference to the figures of the drawings, the oven of the present invention comprises a cooking compartment 2, internally of which a controlled heat cycle can be set. The heat required for performing the heat cycle is produced by one or more heating elements 3 predisposed to generate and transmit a determined heath power internally of the cooking compartment 2. The heating elements 2 can be constituted for example by gas burners, electrical resistances or other elements which heat up by effect of passage of parasite currents or Foucault currents, or by dielectric loss. There are however various other types of heating elements which might be used in the oven of the invention, but the specific choice of a particular heating element over another does not influence the inventive choice at the base of the present oven.

The heating elements are generally arranged in a zone of the cooking compartment which is separate from the zone in which the food products to be cooked are placed. The two zones can be partially separated from one another by surfaces of various shapes which perform the function of improving heat exchange between the heating elements and the cooking compartment. To facilitate air circulation and heat exchange between the heating elements and the cooking compartment, and therefore the food products inside the cooking compartment, one or more air convectors 6 can be predisposed, for example convectors constituted by ventilators equipped with fans, either blades or propellers, predisposed to direct a heated air flow from the heating elements 3 to the cooking compartment.

For the production of steam, one or more atomizers 4, or other suitable means for issuing water towards the atomizers, are predisposed to send a controlled stream of atomized water onto at least one of the heating elements 3. The activating of the atomizers 4 is regulated on the basis of the degree of moisture to be maintained inside the cooking compartment.

The oven comprises means for controlling 5 which are predisposed to actuate the predetermined heat cycle inside the cooking compartment by means of controlling the heating elements 3. In general the control of the heating elements 3 is based on a temperature measurement, which can be performed for example internally of the cooking compartment and/or internally of the food to be cooked (by means of needle sensors) and/or on the surface of the heating elements 3, and on a comparison of the measurements detected with a predetermined temperature. On the basis of the result of the comparison between the detected measurement and the predetermined temperature, the heating elements are activated or deactivated and/or the air flow rate sent by the conveyors (if present) is increased or reduced, according to whether the measured temperature is to be increased or lowered.

The applicant has found that the heat power required for generating the steam needed for cooking generally corresponds to a fraction of the heat power needed for heating the cooking compartment and the food subjected to cooking. A procedure has therefore been set up on the basis of which the said fraction is managed in part separately from the remaining part of the total heating power of the oven, without significantly modifying the overall cooking process. The operation has to be carried out in full conditions of control over both the heat regulation and the need for generating steam when requested during certain stages of the cooking.

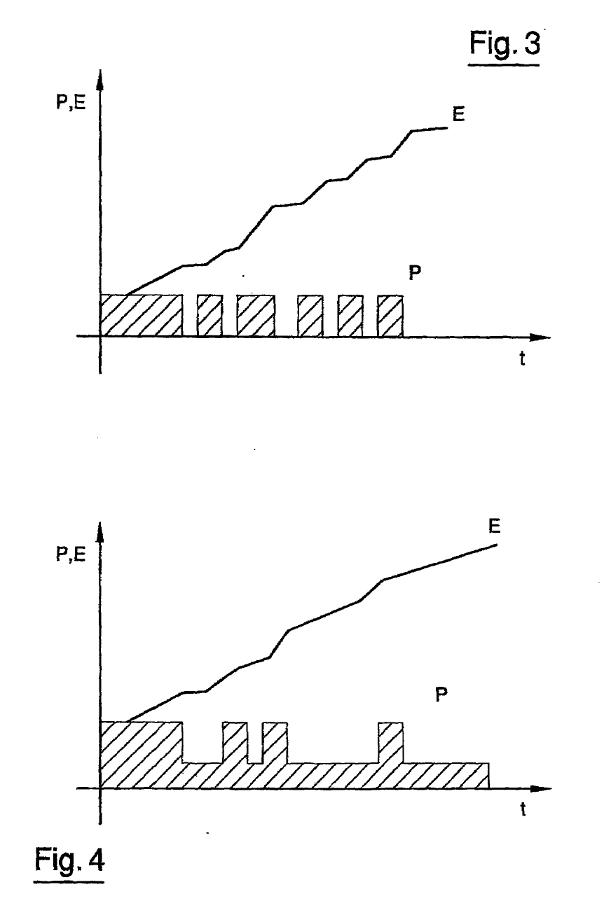

The time integral of the total heat power delivered by the heating elements can be considered as the total heat energy that the oven uses for actuating a determined heat cooking cycle. It has been observed that this is true also considering cooking cycles made up of several successive stages, each of which can be characterized by levels of temperature, moisture and ventilation that are different to preceding or successive stages. The time integral is not substantially modified if the total energy required by the cooking cycle is supplied in a context in which the cooking stages are slightly modified, as long as the temperatures supplied to the product are not significantly modified. The gastronomic result is changed significantly only if the temperatures delivered to the product to be cooked are changed or if the ventilation and moisture conditions are changed, as these influence the heat transmission. FIGS. 3 and 4 provide graphs giving examples of the progression of power and energy in two cooking processes which use about the same total energy, but where in one of the two a circuital solution is used so that the heating power is almost never stopped during the heat-regulation, but is regulated and reduced by an amount which is sufficient to maintain the steam generation active and efficient throughout in at least a zone in direct communication with the cooking compartment in which the food is situated.

As a consequence of the above observations, in the oven of the present invention the heating elements are controlled in a cycle which includes partialisation of the heat energy generated and/or transmitted by the heating elements 3 to the product in the cooking compartment. In this partialisation cycle the temperature of at least one of the heating elements 3 is maintained at a level which is sufficient to determine evaporation of the atomized water. The partialisation of the heat power generated and transmitted by the heating elements enables a predetermined active heat energy to be maintained during the whole cooking process. The active heat power can be maintained at such a level that the temperature inside the cooking compartment is not significantly altered, but is nonetheless sufficiently high to guarantee continuous evaporation of the atomized water and the generation and maintaining of the steam which might be required in the cooking cycle.

In a further special case, for heating the cooking compartment and the food product, the heating elements are normally activated so that the surface thereof can reach temperatures comprised between 300° C. and 600° C. or in some cases above 600° C. To obtain full evaporation of the finely-atomized liquid particles the surface temperature of at least a part of the heating elements can be kept at a temperature just above 110° C.

A first possible example of this control, exercised via the means for control, can be based on direct regulation of the temperature of the heating elements. The heating elements can be activated and maintained at a high temperature, when it is necessary to transfer heat to the cooking chamber and to the product contained therein, or kept at a low temperature when it is necessary to produce steam without significantly interfering with the main heat regulation of the cooking process. The temperature of the heating elements can be regulated by directly acting on the heat source present inside the heating elements. For example, if the heating elements are gas burners, the gas supply flow can be changed. Should the elements be electrical resistances, or other components requiring electrical supply in order to produce heat, the electrical characteristics of the supply can be regulated. Naturally, in the case of heating elements of different nature, other regulation methods will be used, without forsaking the inventive concept at the basis of the present invention.

In a special embodiment of the oven, the heating elements 3 comprise one or more air convectors 6 predisposed to direct an air flow, heated by the heating elements 3, towards the cooking compartment 2. In this case the means for control 5 are predisposed for controlling the air flow sent by the convectors 6 and for controlling the temperature of the heating elements 3 such that the temperature is sufficient to cause evaporation of the water sent by the atomizers 4. The air convectors can be constituted, for example, by ventilators, so that it is possible to regulate the rotation velocity thereof, or, in combination with the ventilators, the convectors can comprise mobile walls which, by means of electromechanical actuator devices, can vary the air flow rate transiting towards the cooking compartment. A combination of the above two forms of ventilation is also possible.

Alternatively, some heating elements, onto which the atomized water is directed, can be constantly maintained at a low temperature to enable a continuous steam production, while other heating elements can be activated or deactivated and can be maintained at a high temperature to transmit heat to the cooking compartment when the cooking cycle requires such. In this example of control, the total heat power can be sub-divided into two or more parts for which there can be different operating and regulating cycles. The heating elements are activated and regulated according to the set temperature for the cooking process (Tset), the instantaneous temperature (T) measured internally of the cooking compartment or the means which transfers the heat from the heating elements to the cooking compartment (dry air, steam or a mixture of air and steam), the instantaneous temperature (Tc) measured in proximity of or internally of the food located in the cooking compartment (2), the flow rate (Vi) produced by the convectors for transmitting the heat to the cooking compartment.

The heat power (P) supplied to the cooking compartment can in general terms be expressed as a function of the above-mentioned measurements, i.e.: P=P (Tset, T, Tc, Vi).

By applying the regulation method described herein, the heat power P supplied to the cooking compartment can be sub-divided into two or more parts. Supposing, for example, a subdivision of the heat power P into two parts P1 and P2, the fraction P1 can thus be expression as a function of the measurements described above, i.e.: P=P (Tset, T, Tc, Vi)

Fraction P2 can be reserved for production of steam. In this case fraction P2 can be expressed as a function of the same measurements which influence fraction P1 and also of the moisture or percentage of instantaneous vapor measured internally of the cooking compartment (U), and possibly of a third and further measurements (which we shall call Ui) which in turn are functions of the system used for atomizing and generating the steam internally of the cooking compartment. In these terms it can be deduced that P2=P2 (Tset, T, Tc, Vi, Uset, U, Ui).

Naturally the various control methods described above can also be combined so that any cooking cycle requested can be actuated. The means for control can also be predisposed to control the atomizers 4 so that the means for control have complete control of the cooking cycle.

The use of a cabled logic control, or a programmed algorithm enables activation of at least a part of the heating elements 3 located internally of the cooking compartment 2, or in direct communication with the chamber 2; the means for control 5 contemporaneously activate the atomizer devices 4 according to a signal generated by a steam probe or a moisture sensor.

The use of a cabled logic control or a programmed algorithm enables regulation of the velocity of at least a fan or the flow rate of another ventilation organ located internally of the cooking compartment 2 or in direct communication there-with; the regulation is controlled by the means for control 5 in response to a signal generated by a steam probe or a moisture sensor.

The use of a cabled logic control or a programmed algorithm enables activation of at least a part of the heating elements 3 located internally of the cooking compartment 2, or in direct communication with the cooking compartment 2, and is controlled by the means for control 5 in accordance with the moisture or percentage of steam U measured or calculated and in accordance with at least one of the following calculated or measured amounts: T, Tc, Vi, and Uset, where: T is the instantaneous temperature measured inside the cooking compartment or in the means which transfers heat from the heating elements to the cooking compartment, Tc is the present temperature measured in proximity of or internally of the food, Vi is the velocity of a fan or a flow rate produced by the convectors for transmitting the heat to the cooking compartment, Uset is the moisture or the percentage of steam set for the cooking process, and in which one of the amounts U, T, Tc and Vi the present measured or presumed amount is not used, but rather the mean value of at least two amounts measured or calculated at different or successive times.

The oven of the present invention thus enables a production of steam to be obtained without time limits or limits linked to the heat cycle realized internally of the cooking compartment. The production of steam is potentially continuous throughout the cooking cycle. A further advantage of the oven of the invention is constituted by the simplicity and immediacy with which the produced steam flow rate can be regulated simply by varying the flow rate of water being atomized on the heating elements.

A further advantage of the oven of the invention is that the described inventive idea can be effectively applied to ovens already available on the market having internal steam production. It is sufficient to provide these ovens with the above-described and illustrated means for control. In this way all the advantages offered by the present invention can be offered, using the constructional elements which are typical in ovens with internal steam production which, as already mentioned in the introductory part of the description, already offer their own characteristics of safety, reliability and economy.

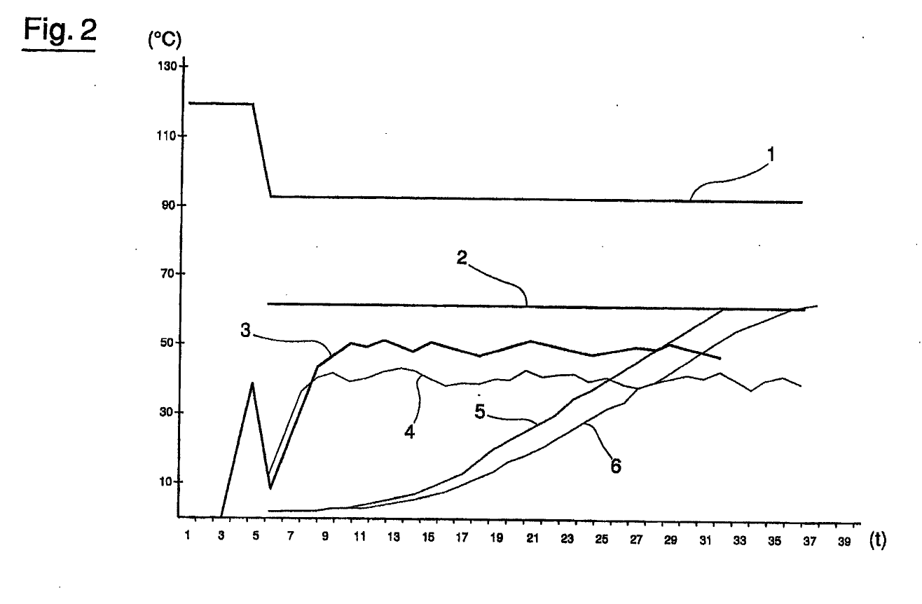

The possibility of continuously producing steam further enables a significant improvement in the cooking processes. In particular, the applicant has found that the possibility of continuously producing steam and effectively regulating it enables cooking cycles to be carried out at lower temperatures than those which are commonly needed to perform a same cooking cycle in traditional ovens, and to significantly reduce cooking times. Thanks to the presence of means for control, the cooking cycle can be sub-divided into successive stages, with duration, temperature and degree of moisture that are different and which overall reduce the length of the cooking cycle. In this way, with a same gastronomic result, the taste and aesthetic characteristics, as well as the nutritional values of the food are better conserved with respect to traditional cooking cycles. A shorter cooking process, together with a slightly lower temperature, leads to a significant reduction in energy consumption, as shown in FIG. 2, where the graphs illustrate the time/temperature ratios of the steam, the cooking compartment and the product to be cooked, and more precisely:

1. the temperature in the cooking compartment of the oven;

2. the temperature the inside of the food must reach;

3. the temperature of the steam produced in the cooking compartment by the means for control constituting the invention;

4. the temperature of the steam produced in the cooking compartment by the tradition method;

5. the temperature inside the cooked product with the means for control of the invention;

6. the temperature inside the cooked product with the traditional method.

FIG. 2 highlights the advantages deriving from the use of means for control and regulation which enable obtaining a higher steam temperature with the same cooking conditions (temperature, moistness and fan velocity in the cooking compartment) as with traditional methods, and therefore a greater heat transfer to the product to be cooked.

What is claimed:

1) An oven for cooking food, comprising: a cooking compartment, internally of which a controlled heating cycle can be actuated; one or a plurality of heating elements, predisposed to generate and transmit a determined heat power internally of the cooking compartment; one or a plurality of atomizers, predisposed to controlledly send atomized water onto or in proximity of at least one of the one or the plurality of heating elements such as to obtain steam required for some cooking processes via evaporation of the water, wherein it comprises means for control, predisposed to actuate the determined heat cycle internally of the cooking compartment by controlling the one or the plurality of heating elements in a partialisation cycle of the heat power generated and/or transmitted to the cooking compartment by the one or the plurality of heating elements, in which partialisation cycle a temperature of at least one of the heating elements is maintained at a level which is sufficient to cause evaporation of the atomized water.

2) The oven of claim 1, comprising a plurality of heating elements, wherein the means for control maintain a temperature of all the plurality of heating elements at a level which is sufficient to cause evaporation of the atomized water.

3) The oven of claim 1, wherein, in at least a stage of the heating cycle realized internally of the cooking compartment, the means for control subdivide all produced heat power directed towards the cooking compartment into at least a first fraction, supplied by some of the plurality of heating elements and prevalently destined for regulating a temperature internally of the cooking compartment, and at least a second fraction, supplied by other of the plurality of heating elements and prevalently destined to evaporate the atomized water.

4) The oven of claim 1, wherein: the one or the plurality of heating elements comprise one or a plurality of air convectors predisposed to direct an air flow which is heated by the one or the plurality of heating elements towards the cooking compartment; the means for control being predisposed for controlling the air flow sent by the one or the plurality of convectors and for controlling the temperature of the one or the plurality of heating elements such that the temperature is sufficient to determine evaporation of water directed by the atomizers.

5) The oven of claim 3, wherein the first fraction of the total heat power supplied to the cooking compartment is regulated according to a selected temperature for a particular cooking process, to an instantaneous temperature measured internally of the cooking compartment, to an instantaneous temperature measured in proximity of a zone in which food to be cooked is located internally of the cooking compartment, and to a flow of air produced by the one or plurality of air convectors.

6) The oven of claim 5, wherein the second fraction of the total heat power supplied to the cooking compartment is regulated according to parameters based on which the first fraction is regulated, in combination with a degree of moisture or a percentage of steam required for a given stage of a cooking process.

7) The oven of claim 6, wherein the second fraction of total heat power supplied to the cooking compartment is regulated according to parameters on a basis of which the first fraction is regulated, in combination with a degree of moisture of a percentage of steam required for a given stage of a cooking process, and with the degree of moisture or percentage of steam being presumed, calculated and/or measured internally of the cooking compartment.

8) The oven of claim 1, wherein the means for control are also predisposed for regulating a flow of water issued by the atomizers.

9) The oven of claim 1, wherein the one or the plurality of heating elements comprise gas burners, the means for control being predisposed for regulating a flow of fuel supplied to the gas burners.

10) The oven of claim 1, wherein the one or the plurality of heating elements comprise electrical resistances, the means for control being predisposed for regulating an electrical supply to the resistances.

11) The oven of claim 1, wherein the one or the plurality of heating elements comprise dielectric loss heaters or parasite current heaters or Foucault current heaters, the means for control being predisposed to regulate an electrical supply to the resistances.

12) An oven constructed according to claim 1, wherein a cabled logic or a programmed algorithm is present so that activation of at least a part of the one or the plurality of heating elements located internally of the cooking chamber or in direct communication with the chamber is controlled by the means for control, which means for control contemporaneously activate the atomizing devices in response to a signal generated by a steam probe or by a moisture sensor.

13) The oven of claim 1, wherein a cabled logic or a programmed algorithm is present so that regulation of at least a fan or a flow rate of other ventilating organs located internally of the cooking compartment, or in direct communication with the cooking compartment, can be made by the means for control in accordance with a signal generated by a steam probe or a moisture sensor.

14) The oven of claim 1, wherein it comprises a cabled logic control or a programmed algorithm, so that the activation of at least a part of the heating elements located internally of the cooking compartment or in direct communication with the cooking compartment is controlled by the means for control in accordance with a level of moisture or a percentage of steam U which is measured or calculated and a level of at least one of following values which are measured or calculated: T, Tc, Vi, and Uset, where: T is an instantaneous temperature measured internally of the cooking compartment or in a means for transferring heat from the heating elements to the cooking compartment, TC is a present temperature in proximity of or internally of the food, Vi is a velocity of a fan or a flow rate produced by the convectors for transmitting the heat to the cooking compartment, Uset is the moisture or the percentage of steam set for the cooking process; in which at least one of the measurements or presumed said values U, T, Tc and Vi is not used, but where a mean value of at least two values which are measured or calculated at different or successive times is used.
